(19) United States
(12) Patent Application Publication
(10) Pub. No.: US 2024/0188026 A1
(43) Pub. Date: Jun. 6, 2024

(54) SELECTIVE REPORTING OF TRACKING AREA IDENTITY TO CORE NETWORK IN NON-TERRESTRIAL NETWORKS

(71) Applicant: Telefonaktiebolaget LM Ericsson (publ), Stockholm (SE)

(72) Inventors: Johan RUNE, Lidingö (SE); Helka-Liina MÄÄTTÄNEN, Espoo (FI)

(21) Appl. No.: 18/285,098

(22) PCT Filed: Mar. 31, 2022
(86) PCT No.: PCT/IB2022/053048

§ 371 Date: Sep. 29, 2023

Related U.S. Application Data
(60) Provisional application No. 63/169,713, filed on Apr. 1, 2021.

(51) Int. Cl. H04W 64/00; H04W 60/04; H04W 76/20; H04W 84/06

(52) U.S. Cl. CPC H04W 64/00; H04W 60/04; H04W 76/20; H04W 84/06

(57) ABSTRACT

A non-terrestrial network (“NTN”) can include a communication device and a network node. The communication device can determine a location of the communication device using global navigation satellite systems (“GNSS”) measurements. The communication device can further report location information based on the location to the network node. In some examples, reporting the location information includes reporting a tracking area identifier (“TAI”) associated with a tracking area (“TA”) in which the communication device is located.

### TECHNICAL FIELD

The present disclosure relates generally to communications, and more particularly to communication methods and related devices and nodes.

### BACKGROUND

In 3^{rd} generation partnership project (“3GPP”) Release 8, the evolved packet system (“EPS”) was specified. EPS is based on the long-term evolution (“LTE”) radio network and the evolved packet core (“EPC”). The EPS was originally intended to provide voice and mobile broadband (“MBB”) services but has continuously evolved to broaden its functionality. Since Release 13, narrowband-internet of things (“NB-IoT”) and LTE for machines (“LTE-M”) are part of the LTE specifications and provide connectivity to massive machine type communications (“mMTC”) services.

In 3GPP Release 15, the first release of the 5^{th} generations system (“5GS”) was specified. The 5GS is a new generation's radio access technology intended to serve use cases such as enhanced mobile broadband (“eMBB”), ultra-reliable and low latency communication (“URLLC”), and mMTC. 5G includes the new radio (“NR”) access stratum interface and the 5G Core Network (“5GC”). The NR physical and higher layers can reuse parts of the LTE specification, and add needed components when motivated by the new use cases. One such component is the introduction of a sophisticated framework for beam forming and beam management to extend the support of the 3GPP technologies to a frequency range going beyond 6 GHz.

In Release 15, 3GPP started the work to prepare NR for operation in a non-terrestrial network (“NTN”). The work was performed within the study item “NR to support Non-Terrestrial Networks.” In Release 16, the work to prepare NR for operation in an NTN network continued with the study item “Solutions for NR to support Non-Terrestrial Network.” In parallel, the interest to adapt NB-IoT and LTE-M for operation in NTN is growing. As a consequence, 3GPP Release 17 includes both a work item on NR NTN and a study item on NB-IoT and LTE-M support for NTN.

There is an ongoing resurgence of satellite communications. Several plans for satellite networks have been announced in the past few years. The target services for these satellite networks vary, from backhaul and fixed wireless, to transportation, to outdoor mobile, to internet of things (“IoT”). Satellite networks could complement mobile networks on the ground by providing connectivity to underserved areas and multicast/broadcast services.

To benefit from the strong mobile ecosystem and economy of scale, adapting the terrestrial wireless access technologies including LTE and new radio access technology (“NR”) for satellite networks is drawing significant interest. For example, the third-generation partnership project (“3GPP”) completed an initial study in Release 15 on adapting NR to support non-terrestrial networks (mainly satellite networks). This initial study focused on the channel model for the non-terrestrial networks, defining deployment scenarios, and identifying the key potential impacts. 3GPP is conducted a follow-up study item in Release 16 on solutions evaluation for NR to support non-terrestrial networks.

FIG. 1 illustrates an example architecture of a satellite network with bent pipe transponders. A satellite radio access network 100 can include: a gateway 160 that connects a satellite network to a core network; a satellite 150 (e.g., a space-borne platform); a terminal 120 (e.g., a wireless device and/or user equipment (“UE”); a feeder link 140 (e.g., a link between the gateway 160 and the satellite 150); and an access link 130 (sometimes referred to as a service link) (e.g., a link between the satellite 150 and the terminal 120). In this example, the gateway 160 connects to a core network via a base station 170. In additional or alternative examples, the gateway 160 connects to the core network via any suitable network node or includes the network node.

The link from the gateway 160 to terminal 120 is often called a forward link, and the link from the terminal 120 to the gateway 160 is often called a return link. Depending on the functionality of the satellite 150 in the satellite radio access network 100, two transponder options may be considered: a bent pipe transponder and/or a regenerative transponder. When using a Bent pipe transponder, a satellite forwards the received signal back to the earth with only amplification and a shift from uplink frequency to downlink frequency. When using a regenerative transponder, a satellite includes on-board processing to demodulate and decode the received signal and regenerate the signal before sending it back to the earth.

Depending on the orbit altitude, a satellite may be categorized as a low earth orbit (“LEO”) satellite, a medium earth orbit (“MEO”) satellite, or a geosynchronous earth orbit (“GEO”) satellite. A LEO satellite is located at a height ranging from 250-1,500 km, with orbital periods ranging from 90-120 minutes. A MEO satellite is located at a height ranging from 5,000-25,000 km, with orbital periods ranging from 3-15 hours. A GEO satellite is located at a height of 35,786 km, with an orbital period of 24 hours.

A satellite may generate several beams over a given area. The footprint of a beam is usually in an elliptic shape, which has been called a cell. The footprint of a beam is also often referred to as a spotbeam (e.g., spotbeam 110 in FIG. 1). The footprint of a spotbeam may move over the earth surface with the satellite movement or may be earth fixed with some beam pointing mechanism used by the satellite to compensate for its motion. The size of a spotbeam depends on the system design, which may range from tens of kilometers to a few thousands of kilometers.

Two of the main physical phenomena that affect satellite communications system design are the long propagation delay and Doppler effects. The Doppler effects are especially pronounced for LEO satellites.

Propagation delay is an important aspect of satellite communications that is different from the delay expected in a terrestrial mobile system. For a bent pipe satellite network (e.g., as the satellite radio access network 100 in FIG. 1), the round-trip delay may, due to the orbit height, range from tens of ms in the case of LEO to several hundreds of ms for GEO. This can be compared to the round-trip delays catered for in a cellular network which are limited to 1 ms. The propagation delay may also be highly variable due to the high velocity of the LEO and MEO satellites and change in the order of 10-100 μs every second, depending on the orbit altitude and satellite velocity.

A second important aspect closely related to the timing, is a Doppler frequency offset induced by the motion of the satellite. The access link may be exposed to Doppler shift in the order of 10-100 kHz in sub-6 GHz frequency band and proportionally higher in higher frequency bands. Also, the Doppler is varying, with a rate of up to several hundred Hz per second in the S-band and several kHz per second in the Ka-band.

### SUMMARY

According to some embodiments, a method of operating a communication device in a non-terrestrial network, NTN, that includes a network node is provided. The method includes determining a location of the communication device using global navigation satellite systems (“GNSS”) measurements. The method further includes reporting location information based on the location to the network node. Reporting the location information includes reporting a tracking area identifier (“TAI”) associated with a tracking area (“TA”) in which the communication device is located.

According to other embodiments, a method of operating a radio access network (“RAN”) node in a non-terrestrial network (“NTN”) that includes a communication device is provided. The method includes determining one or more tracking area identifiers (“TAIs”) to transmit to a core network (“CN”) node, the one or more TAIs being associated with a cell in which the location device. The method further including transmitting the one or more TAIs to the CN node.

According to other embodiments, a method of operating a core network (“CN”) node in a non-terrestrial network (“NTN”) is provided. The NTN serves a communication device that is present in a cell controlled by a radio access network (“RAN”) node of the NTN. The method includes receiving location information associated with the communication device. The location information including information other than a tracking area identifier (“TAI”) or a cell identifier. The method further including determining a list of one or more TAIs to be a be assigned to the communication device based on the location information.

According to other embodiments, a communication device, network node, core network node, computer program, and a computer program product can be provided for performing the above methods.

Various embodiments described herein provide ways to deal with the problems associated with switching of Tracking Area Identities (“TAIs”) in moving NTN cells. For example, to facilitate configuration of suitable TAI lists and to avoid frequent registration procedures.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a satellite network with bent pipe transponders;

FIG. 2 is a schematic diagram illustrating an example of tracking area switch for earth moving beams/cells with hard TAI update;

FIG. 3 is a schematic diagram illustrating an example of tracking area switch for earth moving beams/cells with soft TAI update;

FIG. 4 is a schematic diagram illustrating an example of a description of a polygon;

FIG. 5 is a flow chart illustrating examples of operations of a UE according to some embodiments of inventive concepts;

FIG. 6 is a flow chart illustrating examples of operations of a RAN node according to some embodiments of inventive concepts;

FIG. 7 is a block diagram of a wireless network in accordance with some embodiments;

FIG. 8 is a block diagram of a user equipment in accordance with some embodiments

FIG. 9 is a block diagram of a virtualization environment in accordance with some embodiments;

FIG. 10 is a block diagram of a telecommunication network connected via an intermediate network to a host computer in accordance with some embodiments;

FIG. 11 is a block diagram of a host computer communicating via a base station with a user equipment over a partially wireless connection in accordance with some embodiments;

FIG. 12 is a block diagram of methods implemented in a communication system including a host computer, a base station and a user equipment in accordance with some embodiments;

FIG. 13 is a block diagram of methods implemented in a communication system including a host computer, a base station and a user equipment in accordance with some embodiments;

FIG. 14 is a block diagram of methods implemented in a communication system including a host computer, a base station and a user equipment in accordance with some embodiments;

FIG. 15 is a block diagram of methods implemented in a communication system including a host computer, a base station and a user equipment in accordance with some embodiments; and

FIG. 16 is a flow chart illustrating an example of operations performed by a core network node in accordance with some embodiments.

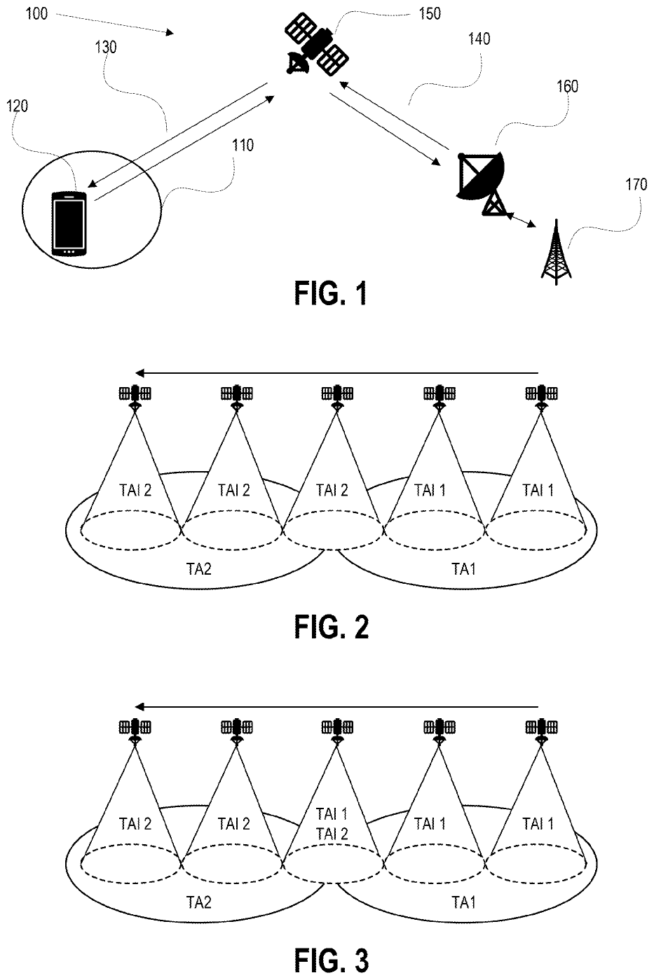

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

In the context of propagation delay, the timing advance the UE uses for its uplink transmissions is essential and has to be much greater than in terrestrial networks in order for the uplink and downlink to be time aligned at the gNB, as is the case in NR and LTE. One of the purposes of the random access (“RA”) procedure is to provide the UE with a valid timing advance (which the network later can adjust based on the reception timing of uplink transmission from the UE). However, even the random access preamble (e.g., the initial message from the UE in the random access procedure) has to be transmitted with a timing advance to allow a reasonable size of the RA preamble reception window in the gNB, but this timing advance does not have to be as accurate as the timing advance the UE subsequently uses for other uplink transmissions. The timing advance the UE uses for the RA preamble transmission is called “pre-compensation timing advance.” Various proposals are considered for how to determine the pre-compensation timing advance, all of which involves information originating both at the gNB and at the UE. Some of the discussed alternative proposals are described below.

One discussed alternative proposal is the broadcast of a “common timing advance” which is valid at a certain reference point, e.g. a center point in the cell. The UE would then calculate how its own pre-compensation timing advance deviates from the common timing advance based on the difference between the UE's own location and the reference point together with the position of the satellite. Herein, the UE acquires its own position using GNSS measurements and the UE obtains the satellite position using satellite orbital data (including satellite position at a certain time) broadcast by the network.

Another discussed alternative proposal is that the UE autonomously calculates the propagation delay between the UE and the satellite, based on the UE's and the satellite's respective positions, and the network/gNB broadcasts the propagation delay on the feeder link, i.e. the propagation delay between the gNB and the satellite. Herein, the UE acquires its own position using GNSS measurements and the UE obtains the satellite position using satellite orbital data (including satellite position at a certain time) broadcast by the network. The pre-compensation timing advance is then twice the sum of the propagation delay on the feeder link and the propagation delay between the satellite and the UE.

Another discussed alternative proposal is that the gNB broadcasts a timestamp (in system information block 9(“SIB9”)), which the UE compares with a reference timestamp acquired from global navigation satellite system (“GNSS”). Based on the difference between these two timestamps, the UE can calculate the propagation delay between the gNB and the UE, and the pre-compensation timing advance is twice as long as this propagation delay.

In terrestrial networks based on NR and LTE, tracking areas are used by the network to coarsely keep track of a UE's whereabouts, especially UEs in a RRC_IDLE or a RRC_INACTIVE state. In such terrestrial networks, a tracking area (“TA”) (not to be confused with the Timing Advance described above) is a set of cells and each cell belongs to one and only one TA. A UE can identify the TA a cell belongs from the Tracking Area Identity (“TAI”), which consists of the public land mobile network (“PLMN”) ID and a Tracking Area Code (“TAC”), and which is broadcast in the system information of each cell.

Furthermore, in terrestrial NR and LTE networks, a UE is configured with a list of TAs (in the form of a list of TAIs), representing the area the UE (in a RRC_IDLE or a RRC_INACTIVE state) is allowed to move around in without informing the network of its location (where this area is referred to as the UE's registration area). If the UE moves (re-selects) to a cell that does not belong to any of the TAs in the UE's configured list of TAs, the UE has to inform the network. This procedure is called Registration in 5G (where the UE sends a Registration Request NAS message to the AMF with the 5GS Registration Type IE set to “mobility registration updating”), while the corresponding procedure is called Tracking Area Update in LTE (where the UE sends a Tracking Area Update Request NAS message to the mobility management entity (“MME”)). The TAI of the UE's current cell is not explicitly included in the Registration Request non-access stratum (“NAS”) message or the Tracking Area Update Request NAS message. Instead, in 5G, the gNB includes it in the User Location Information IE in the NGAP message that conveys the Registration Request NAS message from the gNB to the access and mobility management function (“AMF”) (i.e. the Initial UE Message next generation application protocol (“NGAP”) message or possibly the Uplink NAS Transport NGAP message) Similarly, in LTE, the eNB includes the TAI of the UE's current cell in the TAI IE in the S1AP message that conveys the Tracking Area Update Request NAS message from the eNB to the MME (i.e. the Initial UE Message S1AP message or possibly the Uplink NAS Transport S1AP message). In response to a Registration Request NAS message (or a Tracking Area Update Request NAS message in LTE) the AMF (or the MME in LTE) responds with a Registration Accept NAS message (or a Tracking Area Update Accept NAS message in LTE) including a new TAI list including at least the TAI of the UE's current cell.

The tracking area list a UE is configured with is related to core network (“CN”) initiated paging (i.e. the mechanism by which the network can reach a UE which is in RRC_IDLE state) in the sense that in order to be sure to reach the UE, the CN has to page the UE in all the cells of the TAs in the UE's list of TAs. The CN may page the UE in all these cells at the first page attempt, but the CN may also choose to first page the UE in a smaller number of cells, based on the UE's last known location, and then increase or complement the cells in which the UE is paged in a second attempt in case the UE does not respond to the first page attempt. The CN can also use the UE's current TA for other purposes and therefore the UE's TA, as well as its serving cell ID may be signaled over the RAN-CN interface, e.g. from a gNB to an AMF.

In NR, there is also a RAN initiated paging mechanism which is used when the network needs to reach a UE in a RRC_INACTIVE state. To support RAN initiated paging, a UE can be configured with a RAN-based Notification Area (“RNA”) when it is released to a RRC_INACTIVE state. A RNA may be a list of cells, a list of RAN Areas (identified by a list of RAN Area Codes (“RANACs”), which are unique within a TA) or a list of TAs. As long as a UE in a RRC_INACTIVE state does not leave its configured RNA it does not have to inform the network of its location, but if it leaves the RAN, it has to contact the network to perform RNA update (i.e. send an RRCResumeRequest message with the ResumeCause IE set to “rna-Update”). During RAN initiated paging the UE is paged in its configured RNA.

In addition to Registration (or Tracking Area Update) and RNA update triggered by UE movements, i.e. a UE leaving its configured RNA or list of TAs, a UE may perform timer controlled periodic Registration (or Tracking Area Update) and periodic RNA update.

It is 3GPP's ambition to reuse for NTN as much as possible of the standards specified for NR in terrestrial networks, but reusing the above described TA and RNA concepts in Non-Terrestrial Networks is not straightforward, since the satellites are moving relative to the earth, cells may be moving and gNBs may be moving. Different concepts have been proposed, including that the TAI follows a cell as it moves or that the TAI is fixed to a geographical area and should be adopted and broadcast by the cell passing over the geographical area. The geographically fixed TA concept has the most traction in 3GPP. A similar mechanism is relevant also for earth fixed beams/cells, since the cell covering the cell area may change with satellite and/or feeder link switches (at least conceptually since such events probably will involve change of the physical cell ID (“PCI”)).

In addition, when geographically fixed TAs are used in a moving cells deployment, a cell may have to broadcast multiple TAIs when moving across TA borders. Momentary switching from one TAI to another is referred to as hard TAI update, or hard TAI switch, while broadcasting of multiple (e.g. two) TAIs while a TA border passes through the cell is referred to as soft TAI update, or soft TAI switch.

In a 3GPP email discussion after RAN2#111-e, the specific aspect for earth moving beams/cells is to be brought up regarding the handling of TAs, TAIs, change/update of TAIs, and Registration. During the NTN study item in 3GPP, both hard and soft switch have been considered. Hard switch means that each cell can broadcast only one tracking area code (in between the hard TAI switches). When this is combined with geographically/earth fixed tracking areas, it will create fluctuation at the border areas of these earth fixed tracking areas. Hard TAI update is depicted in FIG. 2.

FIG. 2 illustrates a tracking area switch for earth moving beams/cells with hard TAI update. Soft TAI update requires the network to broadcast more than one TAI in a moving cell while the cell passes over a TA border. This differs from the principle in NR and LTE that a cell belongs to only one TA. Soft TAI update is depicted in FIG. 3.

FIG. 3 illustrates a tracking area update for Earth moving beams with soft TAI update.

3GPP TS 23.032 “Geographical Area Description (GAD)” provides geographical area descriptions which can be converted into an equivalent radio coverage map. The shape definitions use the World Geodetic System 1984 (WGS 84) ellipsoid as a reference. For example, a point and radius are defined as follows.

In regards to the point, the co-ordinates of an ellipsoid point are coded with an uncertainty of less than 3 meters. The latitude of the point is coded with 24 bits: 1 bit of sign and a number between 0 and 223-1 coded in binary on 23 bits. The relation between the coded number N and the range of (absolute) latitudes X it encodes is the following (X in degrees):

$$N \leq \frac{{2}^{23}}{90} X < N + 1 ,$$

except for N=223-1, for which the range is extended to include N+1. The longitude of the point, expressed in the range −180°, +180°, is coded as a number between −223 and 223-1, coded in 2's complement binary on 24 bits. The relation between the coded number N and the range of longitude X it encodes is the following (X in degrees):

$$N \leq \frac{{2}^{24}}{360} X < N + 1$$

In regards to the radius, an inner radius is encoded in increments of 5 meters using a 16 bit binary coded number N. The relation between the number N and the range of radius r (in meters) it encodes is described by the following equation:

5N≤r<5(N+1),

except for N=216-1 for which the range is extended to include all greater values of r. This provides a true maximum radius of 327,675 meters. The uncertainty radius is encoded as for the uncertainty latitude and longitude.

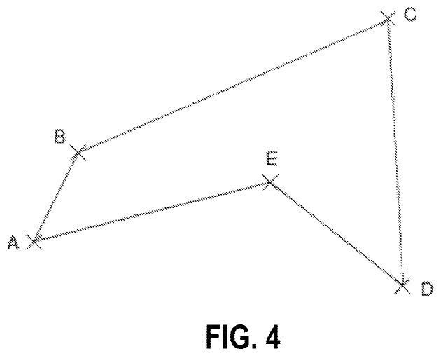

As another example, a polygon is defined as follows in 3GPP TS 23.032. A polygon is an arbitrary shape described by an ordered series of points (in the example illustrated in FIG. 4, A to E). The minimum number of points allowed is 3, and the maximum number of points allowed is 15. The points shall be connected in the order that they are given. A connecting line is defined as the line over the ellipsoid joining the two points and of minimum distance (geodesic). The last point is connected to the first. The list of points shall respect a number of conditions: 1) a connecting line shall not cross another connecting line; and 2) two successive points must not be diametrically opposed on the ellipsoid.

The described area is situated to the right of the lines with the downward direction being toward the Earth's centre and the forward direction being from a point to the next.

This definition does not permit connecting lines greater than roughly 20,000 km. If such a need arises, the polygon can be described by adding an intermediate point.

Computation of geodesic lines is not simple. Approximations leading to a maximum distance between the computed line and the geodesic line of less than 3 metres are acceptable.

As implied above, the ambition to reuse the standardized principles, concepts, and mechanisms from terrestrial NR can result in problems when the concepts developed for terrestrial networks are confronted with the properties of Non-Terrestrial Networks (“NTNs”).

In particular, there are complications around what TAI to broadcast in a cell, specifically a moving cell, at a particular time and place, considering that the broadcast TAI should match the geographically fixed TA.

In some examples, hard TAI switching in moving cells combined with geographically/earth fixed tracking area creates fluctuation at the border areas of these earth fixed tracking areas, for example, toggling between two different TAIs. And related to this, with moving satellites and/or cells (and gNBs in the regenerative payload architecture), cell switches and feeder link switches, the borders of the TAs become fuzzier (e.g., moving back and forth) as perceived by the UEs. The broadcast TAI and thus the TA a UE perceives itself to be located in may change even though the UE itself is not physically moving.

In other examples, soft TAI update/switch in moving cells creates a problem in that it makes it ambiguous which TAI(s) the gNB should include in the User Location Information IE in the Initial UE Message NGAP message (or in the Uplink NAS Transport NGAP message or the Location Report NGAP message). The gNB can report all the broadcast TAIs to the core network or only one of them, but its unclear which of these options that should be specified and, if the option to report a single TAI is specified, its unclear how the gNB should select the TAI to report.

A slightly similar problem occurs for TAI reporting in conjunction with hard TAI update/switch, for example, with regards to which TAI the gNB should report to the core network in the User Location Information IE in the NGAP messages Initial UE Message, Uplink NAS transport, and Location Report. For example, assume a situation where a gNB broadcasts TAI1 in a cell and is (very soon) about to switch from broadcasting TAI1 to broadcasting TAI2 and a UE in the cell sends a Registration Request NAS message to the AMF and the gNB includes TAI1 (which is broadcast in the cell but which is not included in the UE's list of TAIs) in the Initial UE Message NGAP message conveying the Registration Request NAS message from the gNB to the AMF. Then, in response to the UE the AMF sends a Registration Accept NAS message including a new list of TAIs including TAI1 (possibly only TAI1), but not TAI2. If, while this TAI list update is ongoing, or immediately or very soon afterwards, the TAI being broadcast in the UE's cell is switched from TAI1 to TAI2, the UE is immediately triggered to send another Registration Request NAS message, which is obviously suboptimal from a signaling overhead and processing perspective, as well as from a UE energy consumption perspective.

Various embodiments herein facilitate the mechanisms involved in tracking the location of a UE in RRC_IDLE state in an NR based Non-Terrestrial Network, for example, registration procedures and configuration of Tracking Area Identity (TAI) lists allocated to UE(s), in conjunction with switching of TAIs in moving cells. Some embodiments determine which TAI(s) a gNB reports to an AMF, indicated as associated with a UE's current cell. Additional or alternative embodiments determine how to configure suitable TAI lists. Additional or alternative embodiments avoid frequent registration procedures triggered by TAI switches.

In some embodiments applicable to deployments with soft TAI switches in moving cells, the gNB reports to the AMF one out of two or more TAIs that are simultaneously broadcast in a cell, based on explicit UE location information (with finer granularity than a cell) received from the UE (or, in an alternative embodiment, which may be used in multi-beam cells, implicit UE location information based on the beam used for the communication with the UE).

In additional or alternative embodiments applicable to deployments with soft TAI switches in moving cells, the UE reports its location to the AMF in the Registration Request NAS message, and the gNB reports none or all of the TAI(s) broadcast in the UE's cell (in the Initial UE Message NGAP message carrying the Registration Request NAS message between the gNB and the AMF).

In additional or alternative embodiments applicable to deployments with hard TAI switches in moving cells, the gNB bases its selection of TAI(s) to report to the AMF on the time remaining until the next TAI switch in the UE's cell. To this end, when the time until the next TAI switch is shorter than a threshold time, the gNB, in one embodiment, reports the next TAI (e.g., the TAI that will be valid in the cell after the coming TAI switch). In additional or alternative embodiments, the gNB reports both the old (e.g., the currently valid) TAI and the new TAI (e.g., the TAI that will be valid in the cell after the coming TAI switch).

In additional or alternative embodiments applicable to deployments with hard TAI switches in moving cells, the gNB always reports both the current TAI and the next TAI (e.g., the TAI that will be valid in the cell after the next TAI switch). This may optionally be extended to reporting of more than two TAIs, for example, two or more future TAIs in addition to the currently valid TAI, wherein each of the reported future TAIs may be associated with an indication of the time when it will become valid (e.g., essentially a schedule for coming TAI switches).

In additional or alternative embodiments applicable to deployments with hard TAI switches in moving cells, the AMF is aware not only of the TAIs supported by a gNB, but also of the upcoming switches of these TAIs to new TAIs. The AMF may have received this information from the gNB in the way described above in the preceding embodiment, or may have received it from the gNB during the establishment of the NG interface, or through configuration. The AMF may use this knowledge to optimize the TAI list assigned to a UE, for example, to ensure that the TAI list it assigns to a UE includes not only the current TAI of the UE's cell, but also the next TAI that will replace the current TAI in this cell.

Various embodiments described herein provide ways to deal with the problems associated with switching of Tracking Area Identities (“TAIs”) in moving NTN cells, for example, to facilitate configuration of suitable TAI lists and to avoid frequent registration procedures.

Some embodiments herein are described in terms of NR based NTNs, but some embodiments are also applicable in a NTN based on LTE technology. Turning the embodiment descriptions into descriptions of embodiments for an LTE based NTN may only require that affected NR terms be replaced by LTE terms. For example, “gNB” can be replaced by “eNB”, “AMF” can be replaced by “MME”, “NGAP” can be replaced by “S1AP”, “Registration Request” can be replaced by “Tracking Area Update Request,” and “Registration Accept” can be replaced by “Tracking Area Update Accept”.

In some embodiments herein, the term “network” is used to refer to a network node, which can be a gNB (e.g., in an NR based NTN) or an AMF in 5G, but may also be an eNB (e.g., in an LTE based NTN), an MME, a base station, or an access point in another type of network, or any other network node with the ability to directly or indirectly communicate with a UE.

Although some embodiments are described as targeting a RRC_IDLE state and core network initiated paging, some embodiments, embodiment variants, and/or embodiment options are also applicable to RRC_INACTIVE state and RAN initiated paging.

In some embodiments herein, a Global Navigation Satellite Systems (“GNSS”) is described. The most well-known GNSS is the American Global Positioning System (“GPS”), but there are also other also other similar systems which could provide the functionality used in some embodiments. For example, the Russian Global Navigation Satellite System (“GLONASS”), the Chinese BeiDou Navigation Satellite System, and the European Galileo can be used in some embodiments.

In some embodiments herein, the terms “TAI switch” and “TAI update” are used interchangeably. In some embodiments, operations for handling both soft TAI update/switch and hard TAI update/switch in moving cells (combined with geographically fixed TAs) are provided. In some embodiments herein, geographically fixed Tracking Areas are assumed.

Embodiments for soft TAI switch are described below.

In some embodiments, the UE is configured to (or is mandated according to a standard to) explicitly report its location to the gNB when performing an RRC connection establishment procedure. In some examples, this reporting may be a RRCSetupComplete message. In additional or alternative examples, this reporting may include a RRCSetupRequest message and a new MAC CE that is sent together with the RRCSetupComplete message (e.g., in the same MAC PDU as the RRCSetupComplete message). The UE can determine the location to report using GNSS measurements, possibly with additional support from internal movement sensors such as accelerometer(s) and/or gyroscope(s) (e.g., to track the UE's movement and location in between GNSS measurements).

Based on the received UE location, the gNB determines which TA the UE is located in and includes the associated TAI in the User Location Information IE in the Initial UE Message NGAP message. In some examples, the gNB must be aware of the geographical areas the TAIs are associated with, where these areas may be defined using various means of shape, and area defining parameters (e.g., in terms of polygons (possibly with associated location and/or directional information) or shape definitions based on longitude and latitude coordinates or other shape definitions including location and possible directional information). In some examples, shape/area definition means provided in 3GPP TS 23.032 may be used for this purpose. The TA's geographical definitions may be configured by the operations and management (“O&M”) system or by the core network, for example the AMF (e.g., in the NG Setup Response NGAP message).

In additional or alternative examples, the configured or specified rule that the UE should report its location during RRC connection establishment is valid only when multiple TAIs are broadcast in the cell.

In additional or alternative examples, the configured or specified rule that the UE should report its location during RRC connection establishment is valid only when multiple TAIs are currently broadcast in the cell and the purpose of the RRC connection establishment is to send a Registration Request NAS message (e.g., when the Registration Request NAS message is included in the RRCSetupComplete message).

In additional or alternative examples, the configured or specified rule that the UE should report its location during RRC connection establishment is valid only when the purpose of the RRC connection establishment is to send a Registration Request NAS message (e.g., when the Registration Request NAS message is included in the RRCSetupComplete message), irrespective of the number of TAI(s) that is/are currently broadcast in the cell.

In additional or alternative embodiments, a gNB may also report a UE's TAI(s) at other times than during the RRC connection establishment. The gNB may for instance include the User Location Information in the Uplink NAS Transport NGAP message or the Location Report NGAP message (in accordance with a previously received Location Reporting Control NGAP message). In some examples, in case multiple TAIs are broadcast in the cell, the gNB may rely on the latest previously received location information from the UE for the selection of TAI to report to the AMF. In additional or alternative examples, the gNB may retrieve (using a request message) the UE's location from the UE before transmitting the Uplink NAS Transport NGAP message or the Location Report NGAP message. In additional or alternative examples, the gNB may base the choice of whether to rely on a previously received UE location or request fresh location information on how old the previously received UE location information is. For example, if the previously received UE location information is younger than TMaxLocationAge (where this parameter may be configured by the core network (e.g., the AMF) or may be configured by the O&M system), the gNB relies on this previously received UE location information, otherwise the gNB requests a fresh location information from the UE. An alternative is that this choice is based on configuration, for example, received from the core network or received from the O&M system. As yet another option, if the previously received UE location information is older than TMaxLocationAge, the gNB reports all the TAI(s) broadcast in the cell.

In additional or alternative embodiments that may be used in multi-beam cells, the UE location information on which the gNB bases its selection of TAI to report to the AMF is not explicit location information received from the UE, but implicit location information based on the beam used for the communication with the UE.

In additional or alternative embodiments, the gNB may be configured whether to report a selected TAI or all broadcast TAI(s), for example, in the User Location Information IE. The configuration may be provided by the core network or the O&M system. If the core network provides the configuration, the configuration may be UE specific (associated with a certain UE signaling association and valid for other cases than TAI reporting in the Initial UE Message NGAP message) or may be applicable to all UEs. The UE specific configuration could be provided in the Initial Context Setup Request NGAP message, the UE Context Modification Request NGAP message or the Location Reporting Control NGAP or a new NGAP message.

In additional or alternative embodiments, the gNB does not have to be aware of the geographical definitions of the TAs, but instead the UE has this knowledge (at least concerning the TA(s) in its TA list). Instead of reporting its location to the gNB, the UE uses its location to determine which of the broadcast TAIs that is associated with the TA the UE is located in and then the UE reports this TAI to the gNB in the RRCSetupComplete message (or in the RRCSetupRequest message or in a new MAC CE which is sent together with the RRCSetupComplete message (i.e. in the same MAC PDU as the RRCSetupComplete message)). The gNB takes this TAI and includes it in the User Location Information IE that it includes in the Initial UE Message NGAP message (or possibly Uplink NAS Transport NGPA message). The UE may have received this geographical knowledge related to the TA(s) through configuration from the network, e.g. through the broadcast system information or dedicated RRC signaling (e.g. an RRCRelease message) or NAS signaling (e.g. a Registration Accept NAS message), or it may be specified in a standard.

In additional or alternative embodiments, the gNB may be configured such that when it reports one TAI for the UE e.g. in the User Location Information IE, the gNB has to verify that the TAI belongs to the UE's registration area and/or that it matches the TAI the UE's AS layer is indicating to NAS layer. In a variant, the gNB informs the core network whether the reported TAI was verified to be part of the UE's registration area or it is not verified to match UE selection/registration area. To support this feature, the gNB may be aware of the UE's registration area, e.g. through signaling or configuration from the core network or through signaling from the UE.

In some embodiments, the gNB reports all the TAI(s) broadcast in the cell when it sends location information to the core network (e.g., the AMF), for example, in the Initial UE Message NGAP message, the Uplink NAS Transport NGAP message or the Location Report NGAP message (e.g., using the User Location Information IE) and the UE includes its location in the Registration Request NAS message to the AMF. Based on the location information received from the UE, the AMF can determine the UE's current tracking area and can, if needed or desired, assign a new list of TAIs to the UE. As an alternative to including its location information in a NAS message, the UE may include it in a message directed to the gNB, e.g. an RRC message or possibly a MAC message, e.g. the RRCSetupComplete message and the gNB then forward the location information to the AMF in an NGAP message, e.g. an Initial UE Message NGAP message, e.g. in the User Location Information IE (in which case the User Location Information as specified in 3GPP release 16 would have to be extended to accommodate one or more new type(s) of UE location information, e.g. in the form of GNSS coordinates).

In some examples, the UE may be configured, either by the AMF or by the gNB to report its location in certain situations. If configured by the gNB, the configuration may be provided e.g. in an RRCRelease message or in an RRCReconfiguration message or an RRCSetup message. If configured by the AMF, the configuration may be provided to the UE e.g. in a Registration Accept NAS message or a Service Accept NAS message. An AMF or the O&M system may also configure a gNB to report or not report the TAI(s) of a UE's cell.

In some embodiments, the gNB reports none of the TAI(s) broadcast in the cell when it sends UE specific NGAP messages to an AMF, e.g. an Initial UE Message NGAP message, but the UE includes its location in the Registration Request NAS message to the AMF. Based on the location information received from the UE, the AMF can determine the UE's current tracking area and can, if needed or desired, assign a new list of TAIs to the UE. As in embodiment 2, as an alternative to including its location information in a NAS message, the UE may include it in a message directed to the gNB, e.g. an RRC message or possibly a MAC message, e.g. the RRCSetupComplete message and the gNB then forward the location information to the AMF in an NGAP message, e.g. an Initial UE Message NGAP message, e.g. in the User Location Information IE (in which case the User Location Information as specified in 3GPP release 16 would have to be extended to accommodate one or more new type(s) of UE location information, e.g. in the form of GNSS coordinates).

In some examples, the UE's and the gNB's behavior may be configurable by the core network, e.g. the AMF, and/or the O&M system.

In additional or alternative embodiments, the UE's behavior may be configured by the gNB or the AMF and the gNB's behavior may be configured by the AMF or the O&M system. In addition, it may be configurable, e.g. by the AMF or the O&M system, which of the above embodiments and embodiment variants that should be used.

Embodiments for hard TAI switch are described below.

The potential problem of double mobility registration procedures in conjunction with hard TAI switches in a cell, is addressed in number of different embodiments below. In these embodiment descriptions, it is assumed that the cell the UE is located in (and may possibly just have entered) switches from TAI1 to TAI2.

In some embodiments, the TAI that the gNB reports to the AMF, e.g. in the Initial UE Message NGAP message, does not only depend on which TAI that is valid and broadcast in the cell at that point in time, but also on the time remaining until the next TAI switch in the cell. To this end, a threshold time, T2, is specified or configured, or derived autonomously in the gNB, and the following TAI reporting rules apply: while the time until the next TAI switch (i.e. from TAI1 to TAI2) is greater than the threshold T2, the gNB reports TAI1 to the AMF; and when the time until the next TAI switch (i.e. from TAI1 to TAI2) is smaller than or equal to the threshold T2, the gNB reports TAI2 to the AMF. (After the switch from TAI1 to TAI2, the time until the next TAI switch is assumed to be greater than T2.).

In some examples, the threshold time T2 may be specified in a standard or it may be configured in the gNB, e.g. by the O&M system. It is essential that T2 is smaller than the time period between two TAI switches, TTaiSwitchPeriod, e.g. 0□T2<TTaiSwitchPeriod. Therefore, one possible way to define, configure or calculate T2 could be to define it as a certain fraction, f, of the time period between two TAI switches, TTaiSwitchPeriod. (where 0□f<1). Another option is to set T2=MIN(T2max, f□TTaiSwitchPeriod), where T2max e.g. may be T2max=2 seconds.

In additional or alternative embodiments, these operations may be combined with (e.g., be used in parallel with) embodiments targeting hard TAI switching with selective registration in conjunction with TAI switches in NTN, wherein the relation between T1 and T2 should preferably (but not necessarily) be that T2>T1.

In some embodiments, the gNB temporarily reports to the AMF (e.g., in the Initial UE Message NGAP message) both the old and the new TAI (i.e. TAI1 and TAI2) during a short time before the switch. Using a specified or configured (or derived/calculated in the gNB) time threshold, T2 (similar as in embodiment 4), the following TAI reporting rules apply: while the time until the next TAI switch (i.e. from TAI1 to TAI2) is greater than the threshold T2, the gNB reports TAI1 to the AMF; and while the time until the next TAI switch (i.e. from TAI1 to TAI2) is smaller than or equal to the threshold T2, the gNB reports both the old TAI (i.e. the still valid TAI) and the new TAI, i.e. both TAI1 and TAI2. (After the switch from TAI1 to TAI2, the time until the next TAI switch is assumed to be greater than T2 and the gNB consequently reports TAI2).

In some examples, the possible restrictions for T2 (e.g. 0□T2<TTaiSwitchPeriod), and the different options for specification, configuration, derivation and/or calculation of T2 are the same as described for the time threshold T2 in the previous embodiments related to hart TAI switch.

In some embodiments, the gNB always reports the currently valid TAI and the next TAI (e.g. TAI1 and TAI2). For example, while TAI1 is the valid (and broadcast) TAI in the cell, the gNB reports TAI together with the TAI that will be valid after the next TAI switch in the cell, e.g. TAI2. After the switch to TAI2, the gNB will report both TAI2 and the TAI that will be valid in the cell after the next TAI switch, e.g. TAI3.

In some examples, the two TAIs may be accompanied with an indication of when the switch from the current TAI to the next TAI (e.g. from TAI1 to TAI2) will occur. This may be extended to reporting multiple future TAIs (i.e. not only one future TAI, i.e. TAI2). For instance, in addition to the currently valid TAI, TAI1, the gNB may report one or more future TAIs (i.e. TAIs that will be valid in the cell after coming TAI switch(es), e.g. TAI2, TAI3 . . . Optionally, each future TAI may be associated with a time indication of when it will become valid in the cell.

In additional or alternative examples, the TAI switches may be switches as they will be perceived by a stationary UE. Together with the fact that tracking areas should be (at least approximately) fixed to a geographical area, this means that the same TAI may reappear repeatedly at the same location. For instance, the broadcast TAI may toggle between two TAIs, where the toggling is the result of the circumstance that the spatial granularity of the broadcast is a cell and when the cell is moving this makes the actually perceived TA border (as the UE perceives it based on the received broadcast TAIs) oscillate back and forth as the network does its best to approximate the intended geographical area of the TA with its TAI broadcasts.

In some embodiments, the AMF is aware not only of the TAIs supported by a gNB, but also of the upcoming switches of these TAIs to new TAIs. The AMF may know this with cell granularity, or it may only be aware of these TAI support and switches on a per gNB level, while it is unaware of the TAI support per cell. The AMF may have this awareness from configuration data, e.g. inserted in the AMF by the O&M system. Alternatively, the AMF relies on information from the gNB, e.g. information obtained in conjunction with the setup of the NG interface and/or it may receive repeated information or updates of the information related to supported TAIs and upcoming TAI switches from the gNB.

In some examples, the AMF may use this knowledge to optimize the TAI list assigned to a UE, e.g. to ensure that the TAI list it assigns to a UE includes not only the current TAI of the UE's cell, but also the next TAI that will replace the current TAI in this cell (and in addition the TAI list may contain further TAIs selected based on other criteria).

In additional or alternative examples, the AMF's configured and/or received TAI related information may optionally be extended to more than the currently supported TAI(s) of a gNB and the TAI(s) that they will switch to, e.g. including chains of TAI switches together with indications of the times when they will occur (e.g. TAI1 (current) will switch to TAI2 at time T1, TAI2 will switch to TAI3 at time T2, TAI3 will switch to TAI4 at time T3, etc. The AMF may use this extended knowledge to proactively include future TAIs in the list of TAIs it allocates to a UE.

In additional or alternative examples, TAI switches may be switches as they will be perceived by a stationary UE. Together with the fact that tracking areas should be (at least approximately) fixed to a geographical area, this means that the same TAI may reappear repeatedly at the same location. For instance, the broadcast TAI may toggle between two TAIs, where the toggling is the result of the circumstance that the spatial granularity of the broadcast is a cell and when the cell is moving this makes the actually perceived TA border (as the UE perceives it based on the received broadcast TAIs) oscillate back and forth as the network does its best to approximate the intended geographical area of the TA with its TAI broadcasts. Hence, as an example, in the above exemplified series of TAI switches, TAI1 and TAI3 may be the same while TAI2 and TAI4 are the same (but different from TAI1 and TAI3).

In additional or alternative examples, to allow the AMF to make full use of its TAI and TAI switch knowledge, e.g. when optimizing a UE's TAI list, it needs information from the gNB about the TAI(s) of the UE's current cell. To support this, the gNB may report a selected TAI (in accordance with previously described embodiments) or all TAI(s) that is/are associated with and broadcast in the UE's current cell.

Embodiments for UE permission for the geographical location to be reported towards CN are described below. Currently, if the UE's location other than cell ID and TAI is reported to the core network, permission is needed from the UE or the user.

In some embodiments, when the UE reports information about its location to the gNB, the UE attaches information whether or not the reported location may be used by the gNB for further core network related signaling or procedures. This may be indication that is valid for all the times the UE reports its location during the lifetime of the ongoing RRC connection. Alternatively, the indication may be valid only for this specific location reporting occasion (which may be for example any of the option described in the previous embodiments).

In additional or alternative embodiments, the gNB may request for the UE's permission to use the already reported location information, or any location information to be reported during the ongoing RRC connection, for further core network related signaling or procedures. Or the gNB may send be specific request for both location information and permission to use it towards the core network.

Various embodiments herein include that a gNB that supports multiple can base its selection of TAI(s) to report to an AMF (in an NGAP message) to indicate a UE's current TA (i.e. the TA the UE is currently located in) may be based on explicit information received from the UE about the UE's location wherein this location information may be more fine granular than a cell area or a spot beam footprint area. (This is most well-suited for deployments using soft TAI switch, e.g. in moving cells.).

Various embodiments herein include that a gNB that supports multiple TAIs can base its selection of TAI to report to an AMF (in an NGAP message) to indicate a UE's current TA (i.e. the TA the UE is currently located in) may be based on the current time in relation to a planned switch of TAI (to be broadcast) in the UE's current cell (where the time relation may be the time remaining until the planned TAI switch will take place). (This is most well-suited for deployments using hard TAI switch, e.g. in moving cells.).

Various embodiments herein include that an AMF may base its selection of TAI(s) to be included in a list of TAI(s) to be allocated to a UE on either of (or any combination of): the TAI(s) reported from a gNB (in an NGAP message) and indicated as the TAI associated with the UE's current TA (i.e. the TA the UE is currently located in), wherein the gNB has selected the reported TAI(s) based on explicit location information received from the UE; information about planned switches of TAIs in a gNB; or explicit information received from the UE about the UE's location.

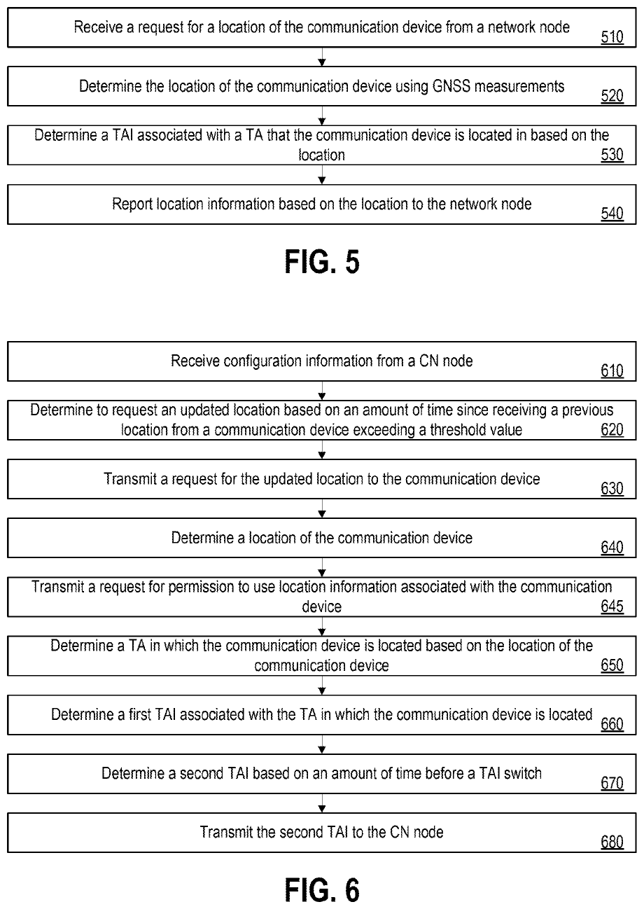

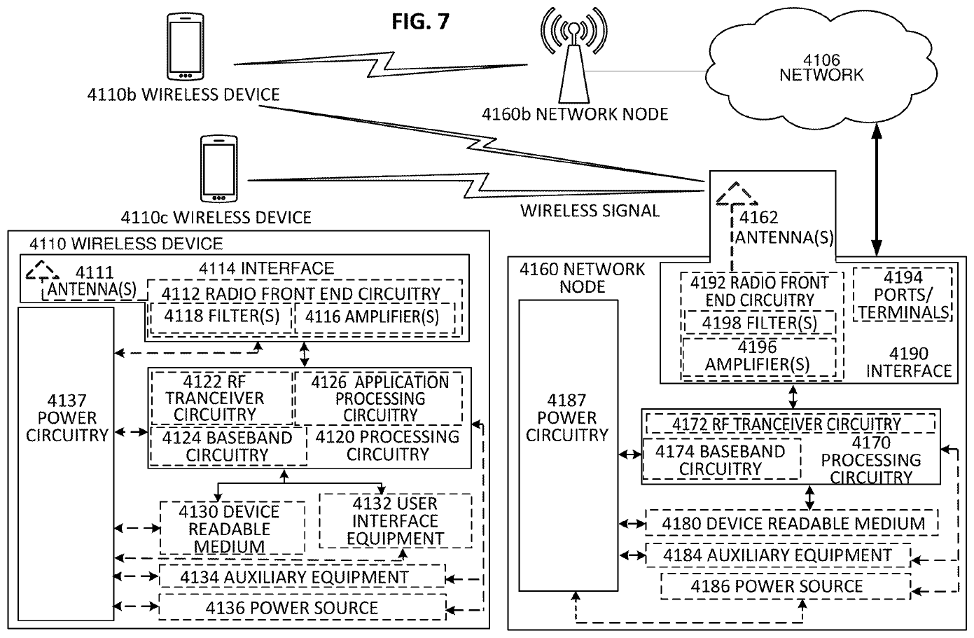

Operations of a communication device (e.g., wireless device 4110 implemented using the structure of the block diagram of FIG. 7) will now be discussed with reference to the flow chart of FIG. 5 according to some embodiments of inventive concepts. For example, modules may be stored in memory 4130 of FIG. 7, and these modules may provide instructions so that when the instructions of a module are executed by respective communication device processing circuitry 4120, processing circuitry 4120 performs respective operations of the flow chart.

FIG. 5 illustrates an example of operations performed by a communication device in a NTN that includes a network node.

At block 510, processing circuitry 4120 receives, via transceiver 4114, a request for a location of the communication device from a network node.

At block 520, processing circuitry 4120 determines the location of the communication device using GNSS measurements. In some embodiments, determining the location includes determining the location using GNSS measurements and measurements from internal movement sensors.

At block 530, processing circuitry 4120 determines a TAI associated with a TA that the communication device is located in based on the location.

At block 540, processing circuitry 4120 reports location information based on the location to the network node. In some embodiments, reporting the location information includes reporting the location. In additional or alternative embodiments, reporting the location information includes reporting the TAI.

In some embodiments, reporting the location information includes reporting the location to the network node during a RRC connection establishment procedure. In additional or alternative embodiments, reporting the location information further includes reporting the location in at least one of a: RRC setup complete message and a RRC setup request message.

In additional or alternative embodiments, reporting the location information includes reporting the location in an uplink non-access stratum, NAS, transport NGAP message.

In additional or alternative embodiments, reporting the location information includes reporting the location in a location report NGAP message.

In additional or alternative embodiments, reporting the location information includes reporting the location in response to at least one of: determining that multiple tracking area identifiers, TAIs, are broadcast in a cell of the network node; and a purpose of the RRC connection establishment is to send a registration request non-access stratum, NAS, message.

In additional or alternative embodiments, reporting the location information further includes transmitting an indication of a period of time during which the location may be used by the network node. The period of time can include at least one of: a lifetime of a radio resource control, RRC, connection between the communication device and the network node; and only for a specific location reporting occasion.

Various operations from the flow chart of FIG. 5 may be optional with respect to some embodiments of communication devices and related methods. In some examples, blocks 510 and 530 are optional.

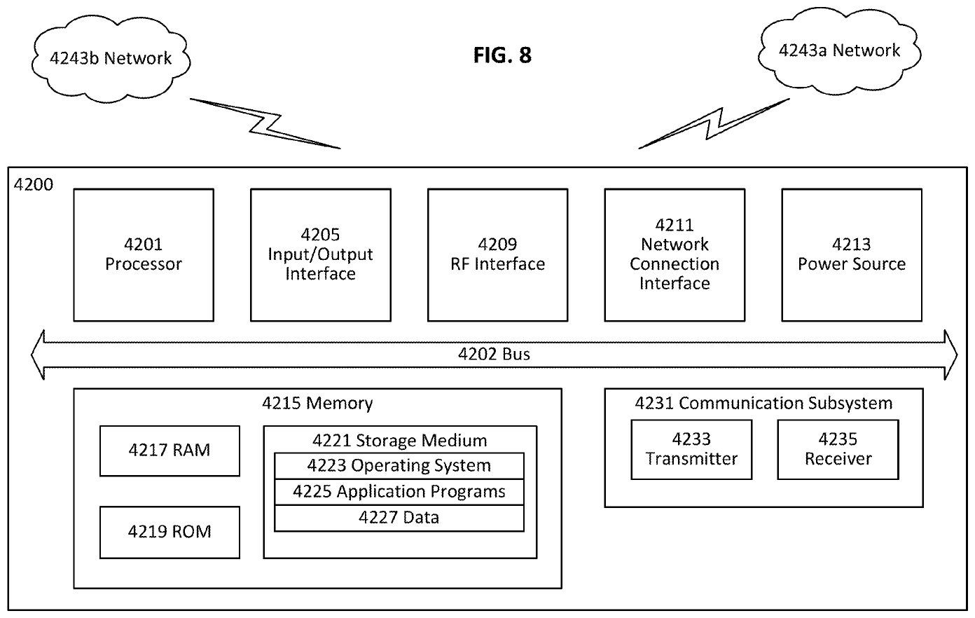

Operations of a network node (implemented using the structure of the block diagram of FIG. 8 will now be discussed with reference to the flow chart of FIG. 6 according to some embodiments of inventive concepts. For example, modules may be stored in memory 4180 of FIG. 8, and these modules may provide instructions so that when the instructions of a module are executed by respective communication device processing circuitry 4170, processing circuitry 4170 performs respective operations of the flow chart. Although FIG. 6 is described below as being performed by network node 4160, the operations can be performed by any network node (e.g., a RAN node or a CN node).

FIG. 6 illustrates an example of operations performed by a RAN node in a NTN that includes (e.g., serves) a communication device.

At block 610, processing circuitry 4170 receives, via network interface 607, configuration information from a CN node.

At block 620, processing circuitry 4170 determines to request an updated location based on an amount of time since receiving a previous location from the communication device exceeding a threshold value.

At block 630, processing circuitry 4170 transmits, via transceiver 601, a request for the updated location to the communication device.

At block 640, processing circuitry 4170 determines a location of the communication device. In some embodiments, determining the location includes receiving the location from the communication device. In additional or alternative embodiments, determining the location includes determining the location based on a beam used for communication with the communication device.

At block 645, processing circuitry 4170 transmits, via network interface 4190, a request for permission to use location information associated with the communication device. The request for permission can include a request for permission to use at least one of: location information previously reported by the communication device; any location information reported by the communication device during a radio resource control, RRC, connection between the communication device and the network node; and information associated with a location of the communication device for core network related procedures.

At block 650, processing circuitry 4170 determines a TA in which the communication device is located based on the location of the communication device.

At block 660, processing circuitry 4170 determines a first TAI associated with the TA in which the communication device is located. In some embodiments, determining the first TAI includes receiving the first TAI from the communication device.

At block 670, processing circuitry 4170 determines a second TAI based on an amount of time before a TAI switch.

At block 680, processing circuitry 4170 transmits, via network interface 4190, the second TAI to the CN node. In some embodiments, transmitting the second TAI includes transmitting a NGAP message to the CN node including the second TAI. In additional or alternative embodiments, transmitting the second TAI includes, responsive to the amount of time being less than a threshold value, transmitting the first TAI and the second TAI to the CN node. In additional or alternative embodiments, transmitting the second TAI includes transmitting the first TAI, the second TAI, and the amount of time before the TAI switch.

In some embodiments, the first TAI is the same as the second TAI.

Various operations from the flow chart of FIG. 6 may be optional with respect to some embodiments of network nodes and related methods. In some examples, blocks 610, 620, 630, 640, 650, and 670 are optional.

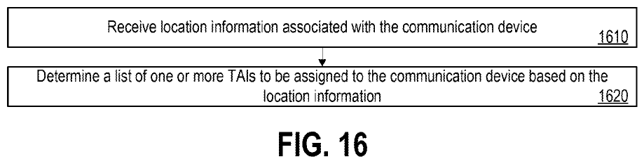

Operations of a core network, CN, node (implemented using the structure of the block diagram of FIG. 8 will now be discussed with reference to the flow chart of FIG. 16 according to some embodiments of inventive concepts. For example, modules may be stored in memory 4180 of FIG. 8, and these modules may provide instructions so that when the instructions of a module are executed by respective communication device processing circuitry 4170, processing circuitry 4170 performs respective operations of the flow chart. Although FIG. 16 is described below as being performed by network node 4160, the operations can be performed by any network node (e.g., a LMF node).

FIG. 16 illustrates an example of operations performed by a core network, CN, node in a non-terrestrial network, NTN, that serves a communication device that is present in a cell controlled by a radio access network, RAN, node of the NTN.

At block 1610, processing circuitry 4170 receives, via network interface 4190, location information associated with the communication device. In some examples, the location information comprises information other than a TAI and a cell identifier.

In some embodiments, receiving the location information includes receiving the location information from the RAN node in a next generation application protocol, NGAP, message.

In additional or alternative embodiments, the location information is associated with a beam, and the beam belongs to the cell and is used when communicating between the RAN node and the communication device.

In additional or alternative embodiments, the location information includes location information that the RAN node has determined based on a message from the communication device.

In additional or alternative embodiments, receiving the location information includes receiving the location information from the RAN node together with one or more tracking area identifiers, TAIs, associated with the cell.

In additional or alternative embodiments, receiving the location information includes receiving the location information from the communication device in a non-access stratum, NAS, message.

In additional or alternative embodiments, the location information is based at least in part on one or more GNSS measurements performed by the communication device.

At block 1620, processing circuitry 4170 determines a list of one or more TAIs to be assigned to the communication device based on the location information. In some embodiments, determining the list of one or more TAIs includes determining the list of one or more TAIs to be a be assigned to the communication based on one or more tracking area identifiers, TAIs, received from the RAN node in a next generation application protocol, NGAP, message.

Various operations from the flow chart of FIG. 16 may be optional with respect to some embodiments of CN nodes and related methods.

Example Embodiments are provided below for reference.

Embodiment 1. A method of operating a radio access network, RAN, node in a non-terrestrial network, NTN, that serves a communication device, the method comprising:
determining one or more tracking area identifiers, TAIs, to transmit to a core network, CN, node, the one or more TAIs being associated with a cell in which the location device; and
transmitting the one or more TAIs to the CN node.

Embodiment 2. The method of Embodiment 1, wherein the one or more TAIs are associated with the cell in which multiple TAIs are broadcast in parallel,
wherein determining the one or more TAIs to transmit comprises determining to transmit all the TAIs being broadcast in parallel in the cell, and
wherein transmitting the one or more TAIs comprises transmitting all the TAIs being broadcast in parallel in the cell to the CN node.

Embodiment 3. The method of Embodiment 1, wherein the one or more TAIs are associated with the cell in which a single TAI that changes with regular or irregular time intervals is broadcast, and
wherein determining the one or more TAIs to transmit comprises determining to transmit to the CN node, a first TAI that is currently being periodically broadcast in the cell and a second TAI that is not currently being periodically broadcast in the cell, but will be broadcast in the cell.

Embodiment 4. The method of Embodiment 1, wherein the one or more TAIs are associated with the cell in which a single TAI that changes with regular or irregular time intervals is broadcast, and
wherein determining the one or more TAIs to transmit comprises determining to transmit to the CN node a second TAI that is not currently being periodically broadcast in the cell, but will be broadcast in the cell.

Embodiment 5. The method of any of Embodiments 3-4, wherein determining the one or more TAIs to transmit comprises determining that the second TAI will be broadcast in the cell based on the time until the TAI will be broadcast in the cell being shorter than a predetermined threshold time.

Embodiment 6. The method of Embodiment 1, wherein determining the one or more TAIs to transmit comprises determining a TAI associated with a tracking area, TA, in which the communication device is located.

Embodiment 7. The method of any of Embodiments 1-6, further comprising:
transmitting a location of the communication device together with the one or more TAIs to the CN node.

Embodiment 8. A method of operating a core network, CN, node in a non-terrestrial network, NTN, that serves a communication device that is present in a cell controlled by a radio access network, RAN, node of the NTN, the method comprising:
receiving (1610) location information associated with the communication device comprising information other than a tracking area identifier, TAI, or a cell identifier;
determining (1620) a list of one or more TAIs to be a be assigned to the communication device based on the location information.

Embodiment 9. The method of Embodiment 8, wherein receiving the location information comprises receiving the location information from the RAN node in a next generation application protocol, NGAP, message.

Embodiment 10. The method of Embodiment 8, wherein the location information is associated with a beam, and
wherein the beam belongs to the cell and is used when communicating between the RAN node and the communication device.

Embodiment 11. The method of Embodiment 8, wherein the location information comprises location information that the RAN node has determined based on a message from the communication device.

Embodiment 12. The method of any of Embodiments 8-11, wherein receiving the location information comprises receiving the location information from the RAN node together with one or more tracking area identifiers, TAIs, associated with the cell.

Embodiment 13. The method of Embodiment 8, wherein receiving the location information comprises receiving the location information from the communication device in a non-access stratum, NAS, message.

Embodiment 14. The method of any of Embodiment 11-13, wherein the location information is based at least in part on one or more GNSS measurements performed by the communication device.

Embodiment 15. The method of any of Embodiments 8-14, wherein determining the list of one or more TAIs comprises determining the list of one or more TAIs to be a be assigned to the communication based on one or more tracking area identifiers, TAIs, received from the RAN node in a next generation application protocol, NGAP, message.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 7 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 7, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 7 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 7 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

FIG. 8 illustrates a user Equipment in accordance with some embodiments.

FIG. 8 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 8, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 8 is a UE, the components discussed herein are equally applicable to a WD, and vice-versa.

In FIG. 8, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4213, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 8, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

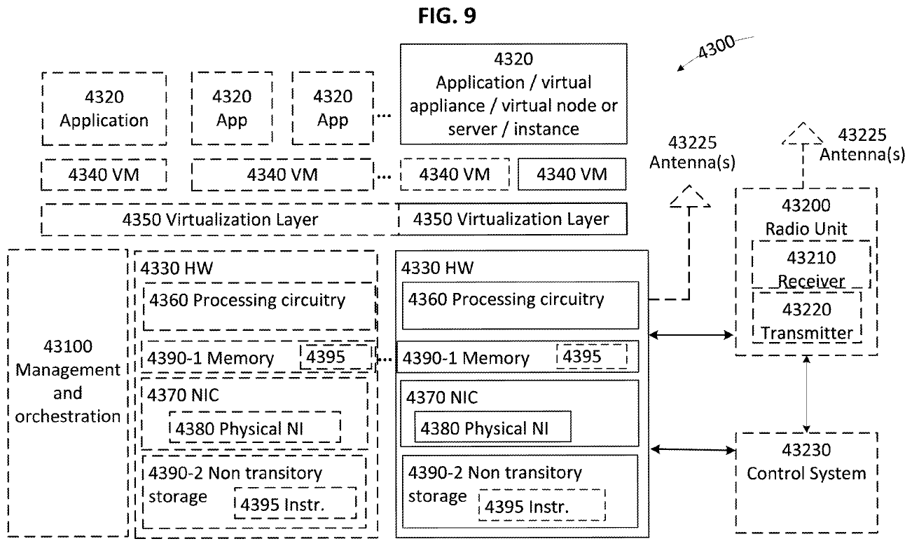

FIG. 9 illustrates a virtualization environment in accordance with some embodiments.

FIG. 9 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 9, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 9.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

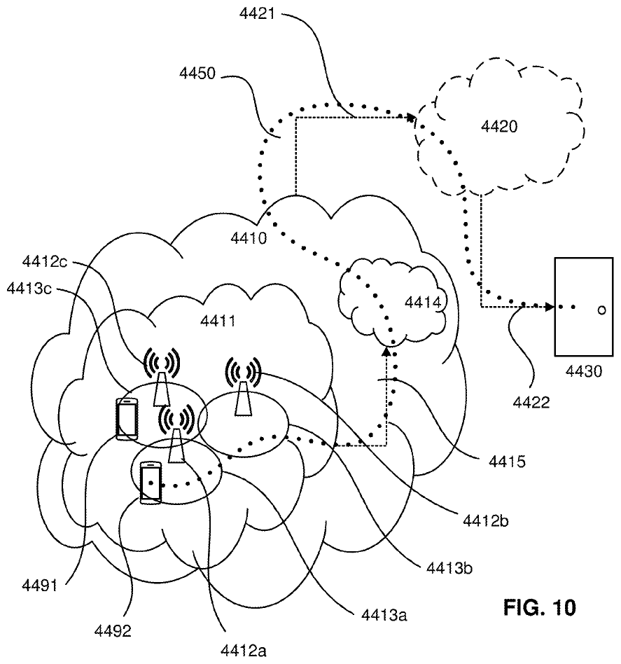

FIG. 10 illustrates a telecommunication network connected via an intermediate network to a host computer in accordance with some embodiments.

With reference to FIG. 10, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 10 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

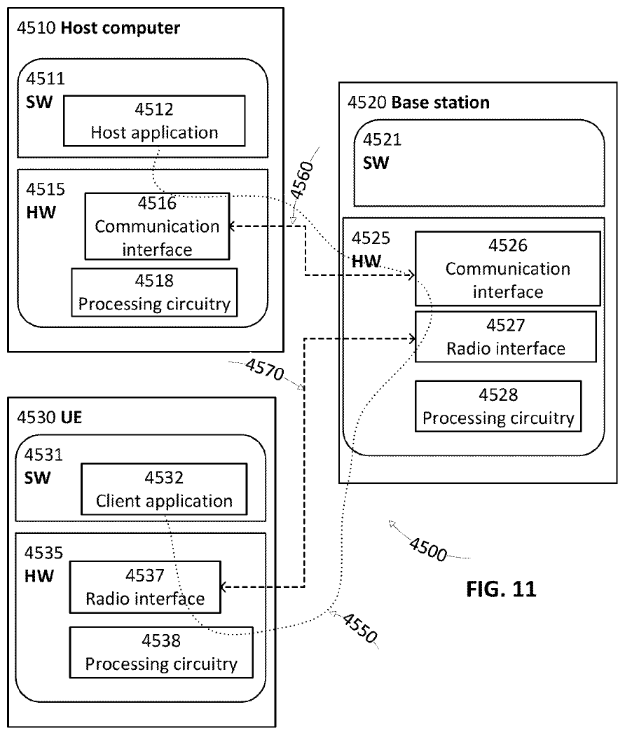

FIG. 11 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 11. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 11) served by base station 4520. Communication interface 4526 may be configured to facilitate connection 4560 to host computer 4510. Connection 4560 may be direct or it may pass through a core network (not shown in FIG. 11) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 11 may be similar or identical to host computer 4430, one of base stations 4412a, 4412b, 4412c and one of UEs 4491, 4492 of FIG. 10, respectively. This is to say, the inner workings of these entities may be as shown in FIG. 11 and independently, the surrounding network topology may be that of FIG. 10.

In FIG. 11, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

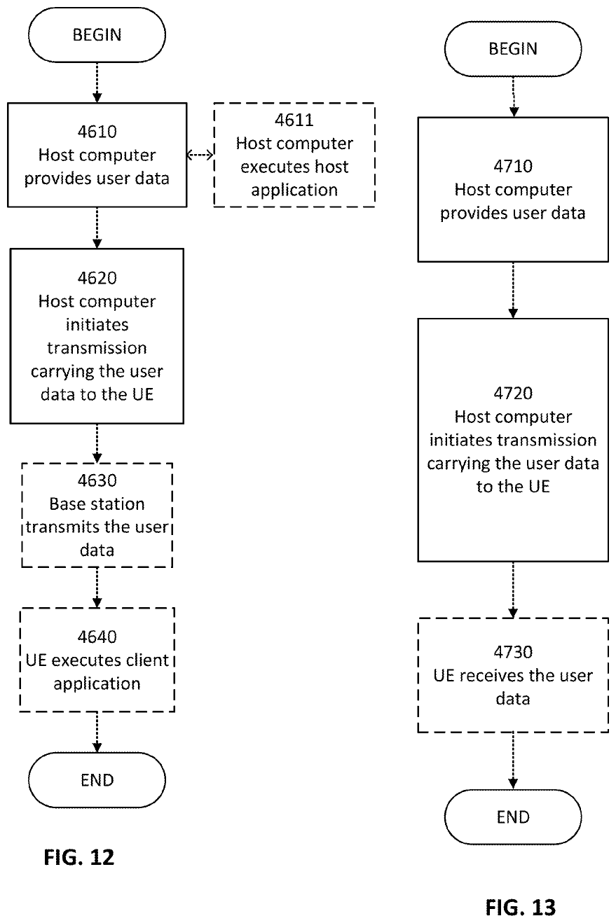

FIG. 12 illustrates methods implemented in a communication system including a host computer, a base station and a user equipment in accordance with some embodiments

FIG. 12 is a flowchart illustrating a method implemented in a communication system, in accordance with one embodiment. The communication system includes a host computer, a base station and a UE which may be those described with reference to FIGS. 10-11. For simplicity of the present disclosure, only drawing references to FIG. 12 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 13 illustrates methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIGS. 10-11. For simplicity of the present disclosure, only drawing references to FIG. 13 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

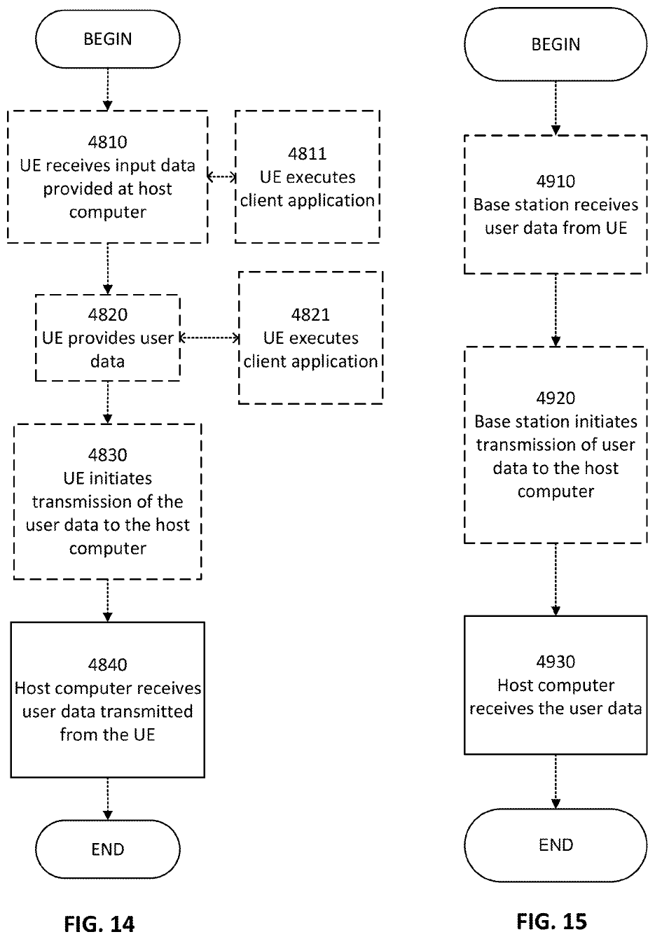

FIG. 14 illustrates methods implemented in a communication system including a host computer, a base station and a user equipment in accordance with some embodiments

FIG. 14 is a flowchart illustrating a method implemented in a communication system, in accordance with one embodiment. The communication system includes a host computer, a base station and a UE which may be those described with reference to FIGS. 10-11. For simplicity of the present disclosure, only drawing references to FIG. 14 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 15 illustrates methods implemented in a communication system including a host computer, a base station and a user equipment in accordance with some embodiments

FIG. 15 is a flowchart illustrating a method implemented in a communication system, in accordance with one embodiment. The communication system includes a host computer, a base station and a UE which may be those described with reference to FIGS. 10-11. For simplicity of the present disclosure, only drawing references to FIG. 15 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a communication device in a non-terrestrial network, NTN, that includes a network node, the method comprising:
determining a location of the communication device using global navigation satellite systems, GNSS, measurements; and
reporting location information based on the location to the network node,
wherein reporting the location information comprises reporting a tracking area identifier, TAI, associated with a tracking area, TA, in which the communication device is located.

2. The method of claim 1, further comprising:
determining the TAI based on at least one of: the location; a list of a plurality of TAIs associated with the NTN; information regarding TAI borders associated with each TAI of the plurality TAIs; and a validity timer associated with a signal broadcast from the network node.

3. The method of claim 1, wherein reporting the location information comprises reporting the location to the network node during a radio resource control, RRC, connection establishment procedure, and
wherein reporting the location information further comprises reporting the location in at least one of a: RRC setup complete message and a RRC setup request message.

4. The method of claim 1, wherein reporting the location information further comprises reporting the location in an uplink non-access stratum, NAS message.

5. The method of claim 1, wherein reporting the location information further comprises transmitting an indication of a period of time during which the location may be used by the network node, and
wherein the period of time comprises at least one of:
a lifetime of a radio resource control, RRC, connection between the communication device and the network node; and
only for a specific location reporting occasion.

6. The method of claim 1, further comprising:
receiving a request for the location from the network node,
wherein reporting the location information comprises reporting the location in response to receiving the request for the location.

7. The method of claim 1, wherein reporting the location information comprises reporting the location in response to at least one of: determining that multiple tracking area identifiers, TAIs, are broadcast in a cell of the network node; and a purpose of the RRC connection establishment is to send a registration request non-access stratum, NAS, message.

8. The method of claim 1, wherein the network node comprises one of a radio access network, RAN, node or a core network, CN, node.

9. A method of operating a radio access network, RAN, node in a non-terrestrial network, NTN, that includes a communication device, the method comprising:
determining one or more tracking area identifiers, TAIs, to transmit to a core network, CN, node, the one or more TAIs being associated with a cell in which the location device; and
transmitting the one or more TAIs to the CN node.

10. The method of claim 9, wherein the one or more TAIs are associated with the cell in which multiple TAIs are broadcast in parallel,
wherein determining the one or more TAIs to transmit comprises determining to transmit all the TAIs being broadcast in parallel in the cell, and
wherein transmitting the one or more TAIs comprises transmitting all the TAIs being broadcast in parallel in the cell to the CN node.

11. The method of claim 9, wherein the one or more TAIs are associated with the cell in which a single TAI that changes with regular or irregular time intervals is broadcast, and
wherein determining the one or more TAIs to transmit comprises determining to transmit to the CN node, at least one of:
a first TAI that is currently being periodically broadcast in the cell; and
a second TAI that is not currently being periodically broadcast in the cell, but will be broadcast within a period of time shorter than a predetermined threshold amount of time.

12. The method of claim 9, wherein determining the one or more TAIs to transmit comprises determining a TAI associated with a tracking area, TA, in which the communication device is located.

13. The method of claim 12, further comprising:
determining a location of the communication device; and
determining the TA in which the communication device is located based on the location of the communication device;

14. The method of claim 13, wherein determining the location comprises determining the location based on a beam used for communication with the communication device.

15. The method of claim 11, wherein transmitting the second TAI comprises transmitting a next generation application protocol, NGAP, message to the CN node including the second TAI.

16. The method of claim 11, wherein the second TAI comprises an updated TAI,
the method further comprising:
determining to request an updated location based on an amount of time since receiving a previous location from the communication device exceeding a threshold value; and
responsive to determining that the amount of time exceeds the threshold value, transmitting a request for the updated location to the communication device.

17. The method of claim 11, further comprising:
determining the second TAI based on an amount of time before a TAI switch from the first TAI being periodically broadcast in the cell in which the communication device is located to the second TAI being periodically broadcast in the cell,
wherein transmitting the second TAI comprises at least one of:
responsive to the amount of time being less than a threshold value, transmitting the first TAI and the second TAI to the CN node;
transmitting the first TAI, the second TAI, and the amount of time before the TAI switch, and
wherein the second TAI is different from the first TAI.

18. The method of claim 11, further comprising:
receiving configuration information from the CN node,
wherein transmitting the second TAI comprises transmitting the second TAI based on the configuration information.

19. The method of claim 11, further comprising:
transmitting a request, to the communication device, for permission to use location information associated with the communication device,
wherein the request for permission comprises a request for permission to use at least one of:
location information previously reported by the communication device;
any location information reported by the communication device during a radio resource control, RRC, connection between the communication device and the network node; and
information associated with a location of the communication device for core network related procedures.

20. A method of operating a core network, CN, node in a non-terrestrial network, NTN, that serves a communication device that is present in a cell controlled by a radio access network, RAN, node of the NTN, the method comprising:
receiving location information associated with the communication device comprising information other than a tracking area identifier, TAI, or a cell identifier;
determining a list of one or more TAIs to be a be assigned to the communication device based on the location information.

21. The method of claim 20, wherein receiving the location information comprises at least one of:
receiving the location information from the RAN node in a next generation application protocol, NGAP, message;
receiving the location information from the RAN node together with one or more tracking area identifiers, TAIs, associated with the cell; and
receiving the location information from the communication device in a non-access stratum, NAS, message.

22. The method of claim 20, wherein the location information is at least one of:
associated with a beam that belongs to the cell and is used when communication between the RAN node and the communication device;
determined based on a message from the communication device; and
determined based at least in part on one or more GNSS measurements performed by the communication device

23. A communication device in a non-terrestrial network, NTN, that includes a network node, the communication device comprising:
processing circuitry; and
memory coupled to the processing circuitry and having instructions stored therein that are executable by the processing circuitry to cause the communication device to perform operations comprising any of the operations of:
determining a location of the communication device using global navigation satellite systems, GNSS, measurements; and
reporting location information based on the location to the network node,
wherein reporting the location information comprises reporting a tracking area identifier, TAI, associated with a tracking area, TA, in which the communication device is located.

24. A communication device in a non-terrestrial network, NTN, that includes a network node, the communication device adapted to perform any of the operations of:
determining a location of the communication device using global navigation satellite systems, GNSS, measurements; and
reporting location information based on the location to the network node,
wherein reporting the location information comprises reporting a tracking area identifier, TAI, associated with a tracking area, TA, in which the communication device is located.

25. A computer program comprising program code to be executed by processing circuitry of a communication device in a non-terrestrial network, NTN, that includes a network node, whereby execution of the program code causes the communication device to perform operations comprising any of the operations of:
determining a location of the communication device using global navigation satellite systems, GNSS, measurements; and
reporting location information based on the location to the network node,
wherein reporting the location information comprises reporting a tracking area identifier, TAI, associated with a tracking area, TA, in which the communication device is located.

26-30. (canceled)
